(19) United States
(12) Patent Application Publication
(10) Pub. No.: US 2016/0081370 A1
(43) Pub. Date: Mar. 24, 2016

(54) DELIVERY SYSTEM FOR DRINKS

(71) Applicant: Nicholas J. Singer, Irvine, CA (US)

(72) Inventor: Nicholas J. Singer, Irvine, CA (US)

(21) Appl. No.: 14/954,839

(22) Filed: Nov. 30, 2015

Related U.S. Application Data
(63) Continuation-in-part of application No. 14/450,113, filed on Aug. 1, 2014.

(51) Int. Cl. A23L 1/00; A23L 2/40; A23L 2/52

(52) U.S. Cl. CPC A23L 1/0008; A23L 2/52; A23L 2/40; A23L 1/0029; A23V 2002/00

(57) ABSTRACT

A water soluble shell or binder is used to encapsulate nutrients, flavoring, other food grade ingredients or combinations thereof together as a single serving or unit. The unit or single serving may be distributed to people to provide nutrition to people in mass casualty situations. In this manner, more nutrients may be delivered since water which has a significant amount of weight and volume need not be transported to the people. Moreover, in normal situations, the water soluble shell or binder dissolves sufficiently quick so that the user can quickly consume nutrients.

### CROSS-REFERENCE TO RELATED APPLICATIONS

This application is a continuation in part application of U.S. Ser. No. 14/450,113, filed on Aug. 1, 2015, the entire contents of which is expressly incorporated herein by reference.

### STATEMENT RE: FEDERALLY SPONSORED RESEARCH/DEVELOPMENT

Not Applicable

### BACKGROUND

The various embodiments and aspects described herein relate to a method and apparatus for distribution of nutrition.

In order to distribute nutrition to a population, the nutrition is preferably distributed in a self-contained package with water. Alternatively, the base nutritional element may be delivered to the population without water. For example, weight lifters may consume protein by mixing a protein powder in water. The protein powder is distributed and sold to weight lifters while water is locally acquired and mixed with the protein powder as desired by the weight lifter at the time of consumption. Unfortunately, the protein powder is delivered in a large bucket and is cumbersome for the weight lifter to manage. There are also other deficiencies in the prior art.

Accordingly, there is a need in the art for an improved method and apparatus for the delivery of nutrition.

### BRIEF SUMMARY

A nutrition delivery apparatus that contains nutrition and may be quickly dissolved and mixed in water is disclosed. The nutrition may be encapsulated with a wrapper (e.g., gelatin capsule or film) or a binder in the form of a tablet. The nutrition may also be impregnated within a structure having a flat film configuration, rope configuration, mesh confirmation, finned configuration, honeycomb configuration or combinations thereof. The film, roll, mesh configured delivery apparatus may be bendable so that it can be rolled up for transportation and storage. The wrapper, binder and the impregnated structure (e.g., flat film, rope, mesh, honeycomb or combinations of these configurations) may dissolve in water fairly quickly so that the nutrition is mixed with water quickly. Moreover, the wrapper, binder and the pre-impregnated structure may be inserted into a water bottle at a later date at the time of consumption or any other container designed to hold, mix or contain water liquid.

More particularly, in an aspect, a delivery device for nutritional supplements is disclosed. The device may comprise a nutrient and a water dissolvable shell. The nutrient may be provided as a powder. The water dissolvable shell is used to hold the powdered nutrient for convenient mixing of the powdered nutrient in water when desired. The water dissolvable shell may be fabricated from a material which sufficiently dissolves in water under one (1) minute for mixing of the powdered nutrient with the water in a quick and efficient manner.

The nutrient may be a protein, vitamin, mineral, proprietary nutritional supplement formulation, meal replacement, food product, drink sweetener, caffeine or combinations thereof. An effervescent material may be mixed with the powdered nutrient to promote mixing of the powdered nutrient with the water as the shell dissolves in water.

The water dissolvable shell may be fabricated from a gelatin material. However, it is also contemplated that the material from which the water dissolvable shell is fabricated may alternatively be a natural, water soluble material including but not limited to rice paper, tapioca powder, Amylose, Amylopectin, Silk (Fibroin) Gelatin, Casein, Pullulan, Guar gum, Soybean polysaccharide film, Agar-agar, Arabinoxylan, Alginate sodium, Callaneenan film, Pectin, Hydroxy propyl cellulose film (i.e., HPC film), Hydroxy propyl methyl film (i.e., HPMC film) Carboxymethyl cellulose film, Carboxymethyl film, Decaglycerin monitor myristate, Glycerin, Crystalline cellulose, Hydroxypropylcellulose or combinations thereof. An exemplary combination is Decaglycerin monitor myristate, Glycerin, Crystalline cellulose, Hydroxypropylcellulose which is provided in film form with a thickness of about 0.004 inches thick. The thickness may have a range between 0.001 and 0.010 inches. The shell may be provided in the form of a semi hard shell, soft capsule or flexible film.

The water dissolvable shell may be sufficiently narrow to be slipped through a mouth of a disposable water bottle. In particular, a width of the shell may be less than about two (2) inch in diameter. However, it is also contemplated that the width of the device may be less than about one (1) inch in diameter.

In another embodiment, a delivery device for nutritional supplements is disclosed. The device may comprise a nutrient and a water dissolvable binder. The nutrient may be provided as a powder. The water dissolvable binder may be used to hold the powdered nutrient in a solid form for convenient mixing of the powdered nutrient in water. The water dissolvable binder may be dissolved in water under one (1) minute for mixing of the powdered nutrient with the water.

The nutrient may be protein, vitamin, mineral, proprietary nutritional supplement formulation, meal replacement, food product, drink sweetener, caffeine or combinations thereof. An effervescent material may be mixed with the powdered nutrient to promote mixing of the powdered nutrient with the water as the binder dissolves in water.

The device may be sufficiently narrow to be slipped through a mouth of a disposable water bottle. In particular, a width of the device may be less than about two (2) inch in diameter. However, it is also contemplated that the width of the device may be less than about one (1) inch in diameter.

In another aspect, a method of manufacturing a delivery device for conveniently mixing a nutrient with water is disclosed. The method may comprise the steps of providing a water dissolvable shell that is sufficiently dissolvable in water under one (1) minute so that water comes into contact with contents disposed within the shell; providing the nutrient as a powder; filling the powdered nutrient in the water dissolvable shell; sealing the water dissolvable shell for holding the powdered nutrient until use when a user disposes the delivery device into a container with water, shakes the container to mix the powdered nutrient as the shell dissolves in the water.

The providing step may include the step of providing a gelatin based water dissolvable shell. Alternatively or additionally, the providing step may include the step of providing a micro film based water dissolvable shell.

In another aspect, a method of manufacturing a delivery device for conveniently mixing a nutrient with water is disclosed. The method may comprise the steps of providing a water dissolvable binder that is sufficiently dissolvable in water under one (1) minute; providing the nutrient as a powder; mixing the binder and the powdered nutrient; filling a die with the mixed binder and powdered nutrient; and compressing the mixed binder and powered nutrient.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a front view of a first embodiment of a nutrition delivery apparatus;

FIG. 2 illustrates the nutrition delivery apparatus of FIG. 1 being inserted into a water bottle;

FIG. 3 illustrates the nutrition delivery apparatus of FIG. 2 as a water soluble wrapper of the nutrition delivery apparatus dissolves to enable mixing of the nutrition in the apparatus to mix with the water;

FIG. 4 is a flow chart illustrating use of the nutritional delivery apparatus;

FIG. 5 is a flow chart illustrating a method for manufacturing first and second embodiments of the nutrition delivery apparatus;

FIG. 6 illustrates a first step of providing an empty first body for filling the nutrition therein with a nozzle;

FIG. 7 illustrates a second step of introducing the nutrition in the first body;

FIG. 8 illustrates a third step of closing the first body with a second body for forming a capsule;

FIG. 9 illustrates a second embodiment of the nutrition delivery apparatus being inserted into the water bottle;

FIG. 10 illustrates the nutrition delivery apparatus of FIG. 9 as a water soluble wrapper of the nutrition delivery apparatus dissolves in water to enable mixing of the nutrition in the apparatus to mix with the water;

FIG. 11 illustrates a third embodiment of the nutrition delivery apparatus being inserted into the water bottle;

FIG. 12 illustrates the nutrition delivery apparatus of FIG. 11 as a water soluble binder of the nutrition delivery apparatus dissolves in the water to enable mixing of the nutrition in the apparatus to mix with the water;

FIG. 13 illustrates a first step of providing an empty die for filling the nutrition therein with a nozzle;

FIG. 14 illustrates a second step of introducing the nutrition and a binder in the die;

FIG. 15 illustrates a third step of compressing the nutrition and the binder for forming a tablet;

FIG. 16 is a flow chart illustrating a method for manufacturing the third embodiment of the nutrition delivery apparatus;

FIG. 17 is a perspective view of a fourth embodiment of the nutrition delivery apparatus having a roll configuration;

FIG. 18 is a perspective view of the fourth embodiment of the nutrition delivery apparatus having a strip configuration;

FIG. 19 is a perspective view of the fourth embodiment of the nutrition delivery apparatus having a honeycomb configuration; and

FIG. 20 is a perspective view of the fourth embodiment of the nutrition delivery apparatus having a rope configuration.

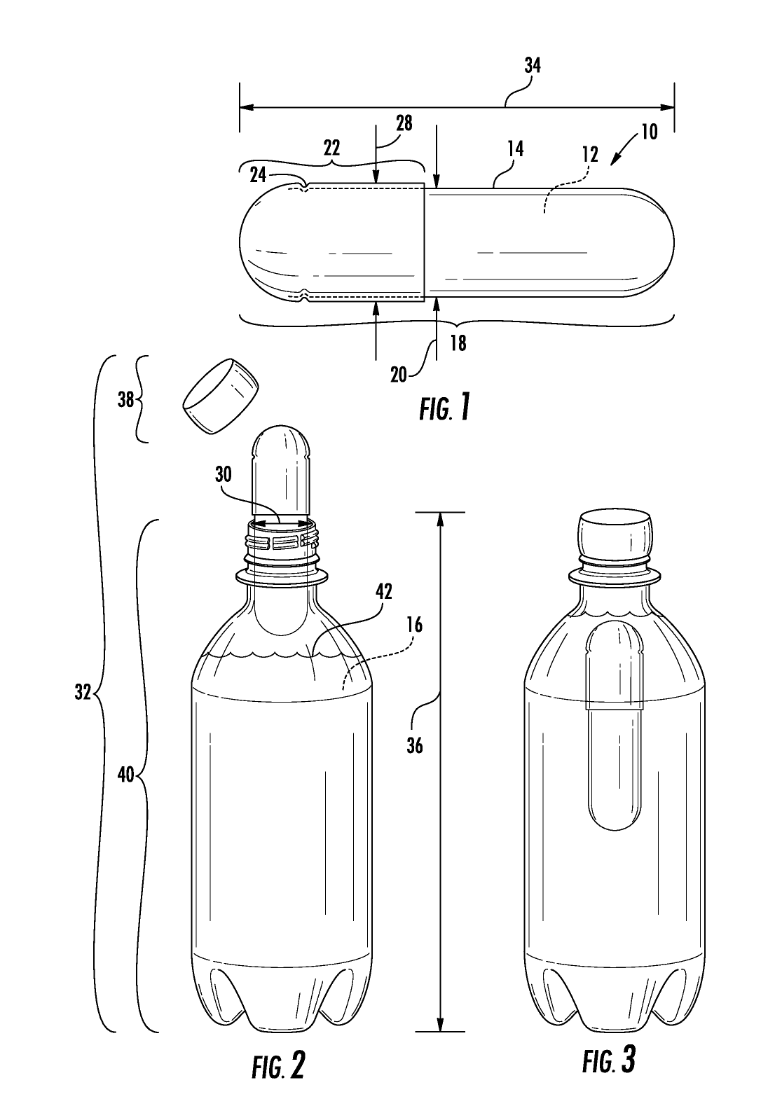

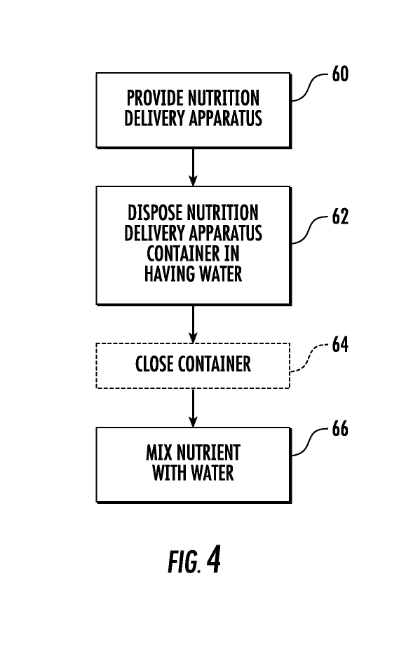

### DETAILED DESCRIPTION

Referring now to the drawings, a method and apparatus 10, 100, 200, 300 for delivering nutrition 12 to a person is shown. In particular, the nutrition 12 is encapsulated within a shell 14, 114 and/or bound together with a binder 214 as a tablet 200. Additionally, the nutrition 12 may be pre-impregnated within a structure (e.g., film or flat sheets, honeycomb, mesh, rope or combinations thereof). The shell 14, 114, the binder 214 and pre-impregnated flexible structure 300 are dissolvable in water 16. Preferably, the shell 14, 114, the binder 214 and the pre-impregnated flexible structure 300 are formulated to dissolve sufficiently quick so that the nutrition 12 can be mixed with the water 16 within one minute. More preferably, the shell 14, 114, the binder 214 and pre-impregnated flexible structure 300 are formulated to dissolve in room temperature water without agitation within one minute, and preferably within 10 seconds so that the nutrition 12 may be consumed quickly after deployment. To deliver nutrition 12 to a person, the apparatus 10, 100, 200, 300 provides a small package that can be conveniently delivered to the person. Water which takes up space and is heavy makes delivering the nutrition 12 pre-mixed with water expensive and impractical. The method and apparatus 10, 100, 200, 300 disclosed herein provides practical applications to athletes, delivery of nutrition 12 in mass casualty situations and combat situations, supplementation, and other real-life problems.

The nutrition 12 may consist of proteins, protein formulations, carbohydrates, fats, vitamins, minerals, proprietary nutritional supplement formulation, meal replacement, food product, drink sweetener, caffeine, consumable additives or combinations thereof. The nutrition may be designed as a vitamin supplement, energy formulation, weight loss formulation, energy formulation, workout recovery formulation, pre-workout formulation, memory enhancement formulation and knee and joint repair formulation. The proprietary nutritional supplement may include combinations of vitamins and supplements to accomplish a desired goal such as weight loss, increased energy, recovery after workout, pre-workout, memory enhancement and joint repair. However, the nutrition 12 may be replaced with other types of food products. By way of example and not limitation, the food products may be flavoring, coloring. The nutrition 12 may also be combined with the food product and provided in the shell 14, 114 and/or held together with the binder 214. The nutrition 12 or food product may be dissolvable in a liquid 16 (e.g., water) and/or suspended therein. Additionally, it is also contemplated that the nutrition 12 and/or food product may be homogeneously or heterogeneously mixed with the liquid 16. It is also contemplated that the nutrition 12 and/or food product may be partially dissolvable in the liquid 16 so as to form a combination homogeneous and heterogeneous mixture with the liquid 16. For the purposes of clarity and simplification, the methods and apparatuses 10, 100, 200, 300 described herein are discussed in relation to delivering nutrition 12 to a person for subsequent mixture by the person with liquid 16. However, it is also contemplated that the various aspects described herein may be applicable to delivering other food products excluding nutrition 12 or in combination with nutrition 12 to the person for subsequent mixture by the person with liquid 16.

Referring now to FIG. 1, the apparatus 10 for delivering nutrition 12 to a person is shown. The nutrition delivery apparatus 10 has a quick dissolve shell 14 in the form of a capsule 14. The interior and/or exterior surface of the shell 14 may have indicia (e.g., words, logo, design or combinations thereof) imprinted thereon. The capsule 14 may be fabricated from a gelatin material. Alternatively or in combination with the gelatinous material, rice powder, rice paper, tapioca powder may be formulated to be dissolve in room temperature drinking water within a short period of time (e.g., less than 1 minute, and more preferably less than 10 seconds). The gelatinous material may be infused with color. Also, the exterior and/or interior surface of the capsule 14 may have indicia (e.g., words, logo, design and/or combinations thereof) imprinted thereon. The capsule 14 may have a hard shell with the nutrition 12 disposed therein. In this case, the nutrition 12 may be in the form of dry granules or powder. Alternatively, the capsule 14 may have a soft shell with the nutrition 12 disposed therein. In this case, the nutrition 12 may be dissolved or suspended in a carrier liquid (e.g., oil). The capsule 14 may be a two-piece hard shell component, as shown in FIG. 1. In particular, a first body 18 may have an outer diameter 20 and be capable of holding the nutrition 12 therein. A second body 22 may have a snug fit over the open end portion of the first body 18. Moreover, the second body 22 may have a lip 24 that fits within a groove 26 formed in the first body 18 for holding the second body 22 on the first body 18. With the nutrition 12 disposed within the capsule 14, the nutrition delivery apparatus 10 may be transported in bulk to stores or mass casualty situations for providing nutrition 12 to people when needed.

The capsule 14 may also have an outer diameter 28 defined by the second body 22. Preferably, the outer diameter 28 of the capsule 14 is smaller than an inner diameter 30 of a mouth of the water bottle 32. The inner diameter 30 of the mouth of the water bottle 32 may be about ½ inch to about 2″. The mouth is sufficiently small so that the person cannot access the interior of the water with his or her finger. The water bottle 32 may be a traditional disposable water bottle 32 such as those sold by water bottling manufacturers. Additionally, the capsule 14 may have a length 34 that is shorter than an internal height 36 of the water bottle 32. Preferably, the capsule 14 is less than one half the height 36 of the water bottle 32. More preferably, the capsule 14 has an outer diameter 28 of about ¾ inch to two (2) inches and a length 34 of two (2) to eight (8) inches. The capsule 14 is shown as being spherical at the opposed end portions with an elongate cylindrical mid section. However, other configurations are also contemplated. By way of example and not limitation, the opposed end portions may have a flat end cap.

The nutrition delivery apparatus 10 may be delivered to stores for further distribution to the public or to an area experiencing a natural disaster or pandemic. People may be sustained by the nutrition 12 within the nutrition delivery apparatus 10 by mixing the nutrition delivery apparatus 10 with water locally acquired. In this manner, the volume and weight of the water does not have to be transported with the nutrition.

By way of example and not limitation, people may insert the nutrition delivery apparatus 10 into the water bottle 32. The user may acquire water 16 locally. The water discussed herein may be drinking water with a pH between about 6.5 to about 8.5. The temperature of such drinking water may be between 60° F. and 85° F. The nutrition delivery apparatus 10 may be transported to the person when needed such as during time of combat, mass casualty and other pandemics. The user may remove a bottle cap 38 from a body 40 of the water bottle 32. Since a water level 42 is typically close to the top of the body 40, the user may drink some of the water 16 in the water bottle 32 to lower the water level 42. The nutrition delivery apparatus 10 may be inserted 62 into the mouth of the water bottle 32. When the nutrition delivery apparatus 10 is inserted into the mouth of the water bottle 32, the nutrition delivery apparatus 10 may remain in a non-agitated state in that there is no external force (e.g., tongue, finger) directly contacting and rubbing against the nutrition delivery apparatus 10 to facilitate dissolution. The nutrition delivery apparatus 10 displaces the water 16 or raises the water level within the water bottle 32. Preferably, the user emptied out the water 16 from the water bottle 32 just enough for the water 16 not to spill over when the nutrition delivery apparatus 10 is inserted into the water bottle 32. Once the nutrition delivery apparatus 10 is inserted into the water bottle 32, the user places 64 the bottle cap 38 on to the body 40 to seal 54 the water 16 and the nutrition delivery apparatus 10 in the body 40 of the water bottle 32.

When the nutrition delivery apparatus 10 is inserted into the body 40, the shell 14 comes into contact with the water 16 disposed in the body 40 of the water bottle 32. Upon contact, the shell 14 begins to dissolve into the water 16 so that the nutrition 12 disposed within the shell 14 begins to mix 66 with the water 16. As the water 16 dissolves the shell 14, the nutrition 12 disposed within the shell 14 begins to mix 66 with the water 16. Optionally, the user may shake the water bottle 32 to more evenly dispersed the nutrition 12. However, shaking is not necessary to dissolve the shell 14 in under 1 minute. Once mixed, the user removes the bottle cap 38 from the body 40 then drinks the water 16 mixed with the nutrition 12.

The method and apparatus 10, 100, 200, 300 described herein allow for inexpensive distribution of nutrition 12 by not having to transport water 16 with the nutritional elements.

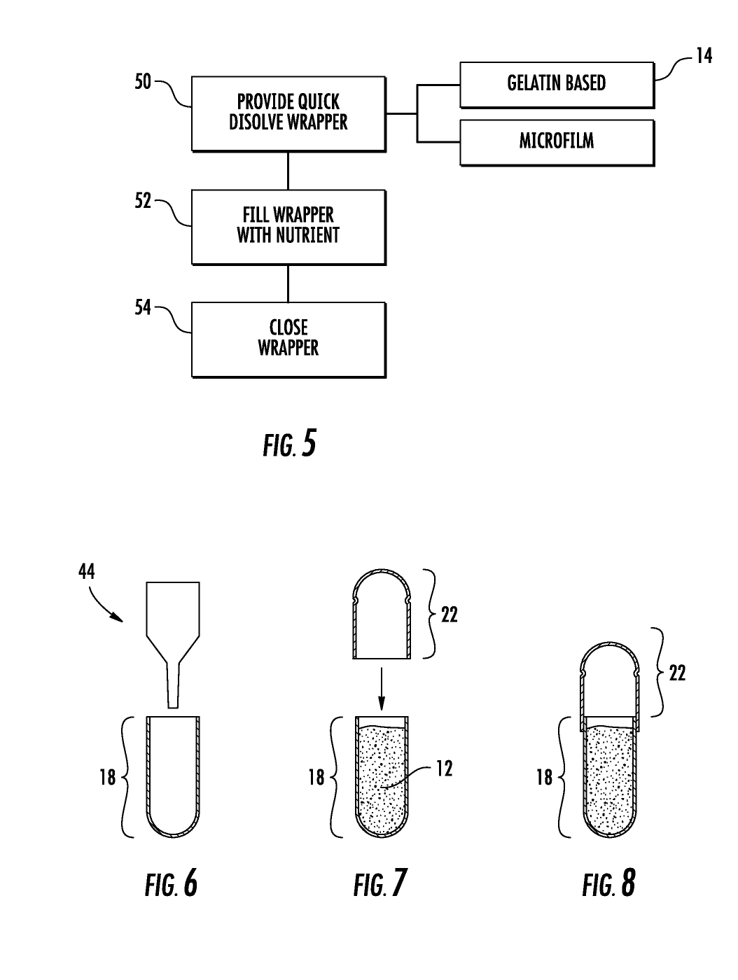

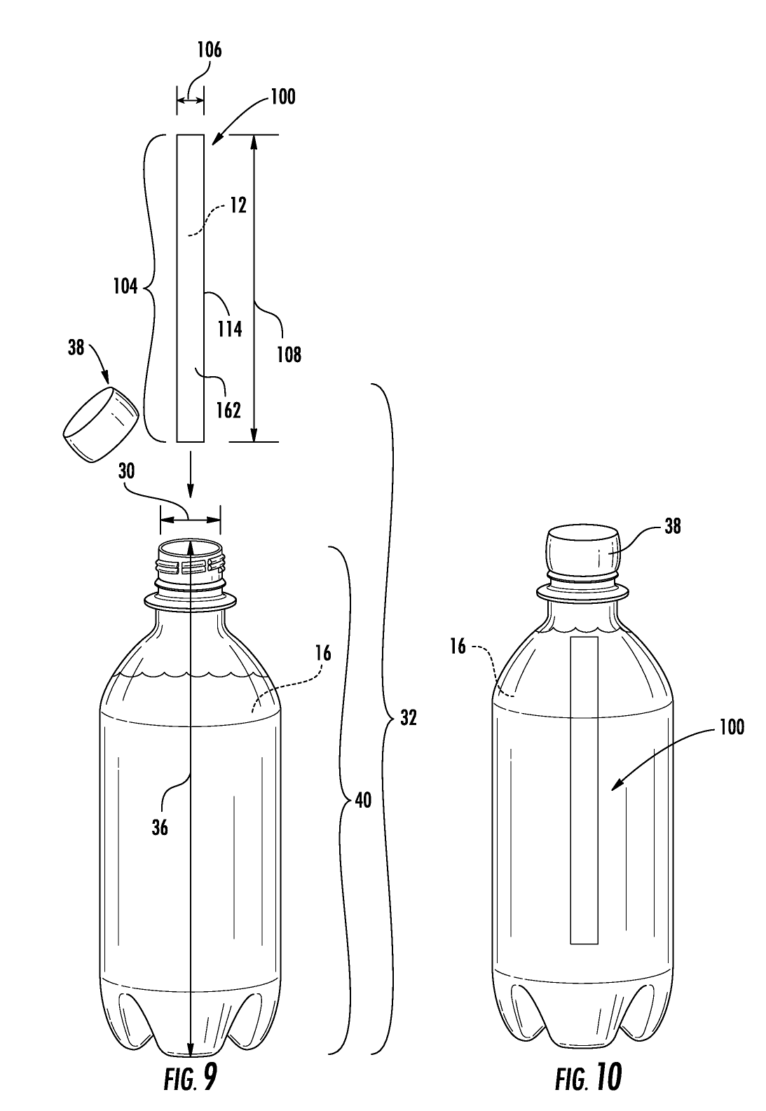

Referring now to FIGS. 5-8, a method for manufacturing the nutrition delivery apparatus 10 is shown. In particular, the quick dissolve shell 14 is provided 50. The quick dissolve shell 14 is provided in two parts, namely, the first body 18 and a second body 22. Initially, the first body 18 is placed under a nozzle 44 which dispenses the nutrition 12 therethrough. The nozzle 44 disposes 52 the nutrition 12 within the cavity 204 of the first body 18. Thereafter, the second body 22 is disposed over the first body 18 then pressed over the first body 18 to seal 54 the nutrition 12 in the shell 14. This forms the nutrition delivery apparatus 10.

Referring now to FIGS. 9 and 10, a second embodiment of the nutrition delivery apparatus 100 is shown. In this embodiment, the nutrition 12 is provided as a flexible edible film 102. The film 102 may be a water soluble polymer film. The flexible film 102 is formed as a pouch 104 for holding the nutrition 12 therein. The pouch 104 has a width 106 which is smaller than the inner diameter 30 of the water bottle 32 so that the nutrition delivery apparatus 100 may be inserted (or slipped) into the mouth of the water bottle 32. Moreover, the pouch 104 has a length 108 which is smaller than the height 36 of the water bottle 32. The length may be between 2 inches to 6 inches. More preferably, the length 108 of the pouch 104 is about one half or less than the height 36 of the water bottle 32.

Similar to the first embodiment, the user removes (i.e., un-screws) the bottle cap 38 off of the body 40 of the water bottle 32. The user may drink a portion of the water 16 in the body 40 to make room for the volume to be displaced by the nutrition delivery apparatus 100. The nutrition delivery apparatus 100 is inserted into the body 40 through the mouth of the body 40. Once the nutrition delivery apparatus 100 is disposed 62 within the body 40, the bottle cap 38 is used to seal 54 off the mouth of the body 40, as shown in FIG. 10. As soon as the nutrition delivery apparatus 100 contacts the water 16, the film 102 begins to dissolve in the water 16 and the nutrition 12 begins to mix 66 with the water 16. Optionally, the user may shake the water bottle 32 to facilitate further mixing 66 until all of the nutrition 12 is mixed with the water 16. However, shaking is not required to dissolve the film 102 in under 1 minute. Thereafter, the user may remove the bottle cap 38 and drink the water 16 mixed with nutrition 12.

To manufacture the nutrition delivery apparatus 100, the film 102 is provided as a pouch 104. One end of the pouch 104 is opened so that the nozzle 44 may be disposed over or in the opening for filling the pouch 104 with nutrition 12. After the nutrition 12 is disposed 62 within the pouch 104, the pouch 104 may be sealed 54 for storage and distribution.

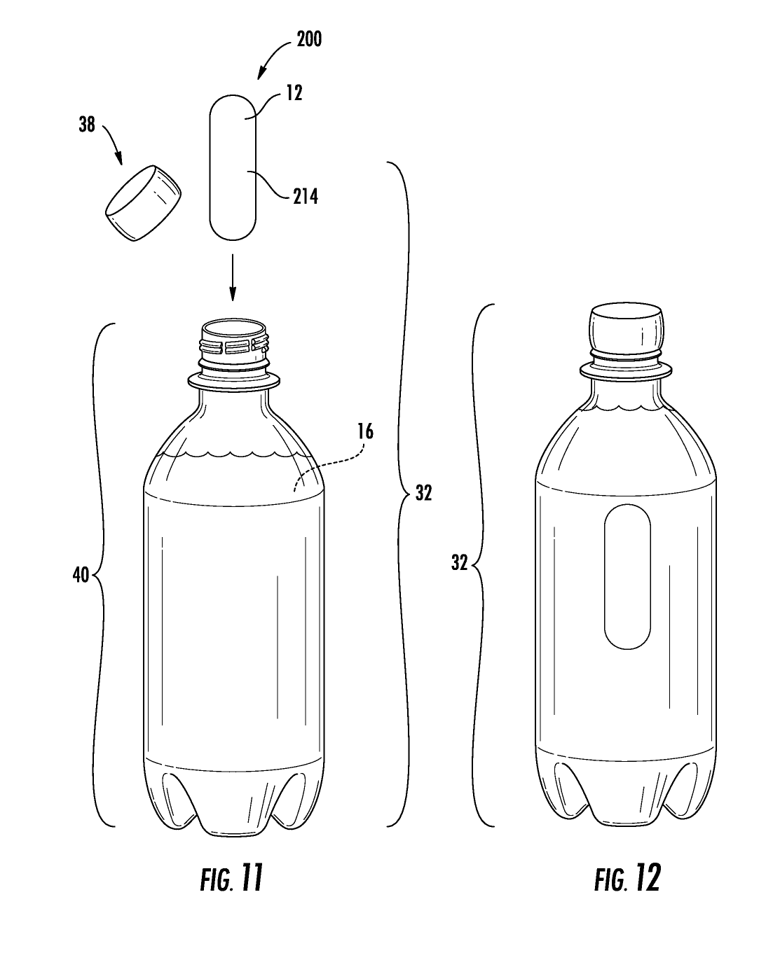

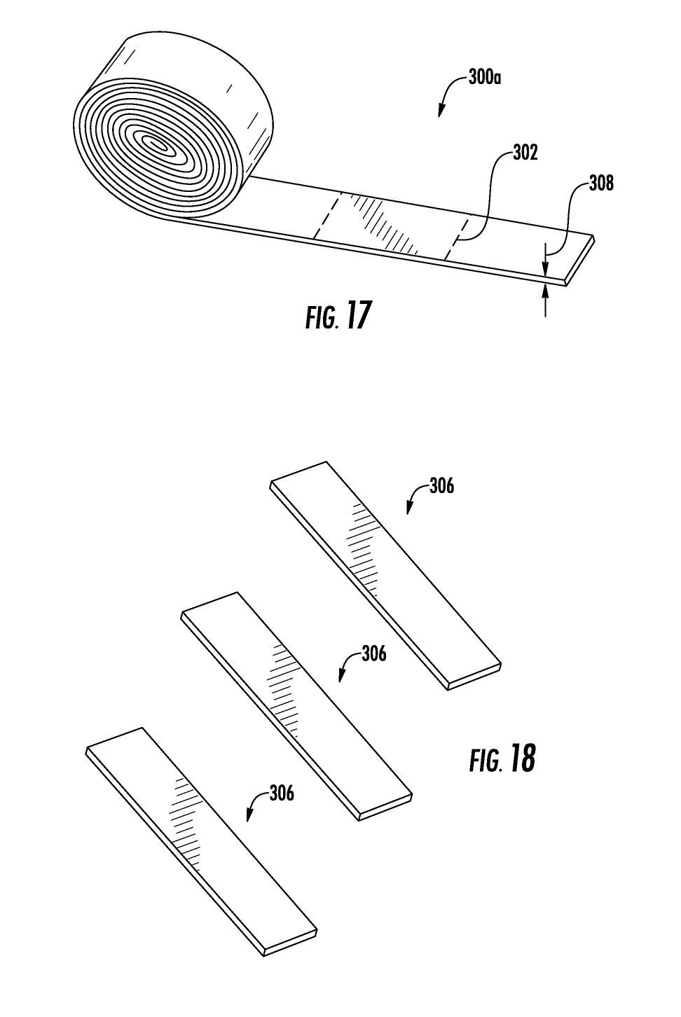

Referring now to FIGS. 11-16, a third embodiment of the nutrition delivery apparatus 200 is shown. The nutrition delivery apparatus 200 tablet is formed so that the nutrition 12 is held together with the binder 206. The binder 206 may be sodium bicarbonate, stearic acid and/or magnesium stearate. The binder 206 is water 16 dissolvable. As such, the nutrition delivery apparatus 200 begins to mix 66 the nutrition encapsulated with the binder 206 as soon as the nutrition delivery apparatus 200 is inserted into the water 16 in the water bottle 32. After inserting the nutrition delivery apparatus 200 in the water 16, the bottle cap 38 is used to seal off 54 the mouth of the water bottle 32. Optionally, the user may shake the water bottle 32 to facilitate mixing 66. However, shaking is not required to dissolve the nutrition delivery apparatus in under one minute. When the binder 206 has completely dissolved, the nutrition 12 may be fully mixed 66 with the water 16. The user may remove the bottle cap 38 to drink the water 16 with nutrition 12. Alternatively, the nutrition 12 may be bound together with the binder 206 and an effervescent material 208 to facilitate mixture 66 of the nutrition 12 with the water 16. In this case, the bottle cap 38 is not placed on the body 40 of the water bottle 32. Rather, the bottle cap 38 is left off of the body 40 so that the effervescent material 208 may produce gas and escape into the atmosphere. The nutrition delivery apparatus 200 may be provided in the form of a tablet and be sized and configured to be able to fit within the mouth opening of the body 40. However, it is also contemplated that the bottle cap 38 may be threaded onto the body 40 of the water bottle 32 while allow the effervescent material 208 to facilitate mixture 66 of the nutrition with the water.

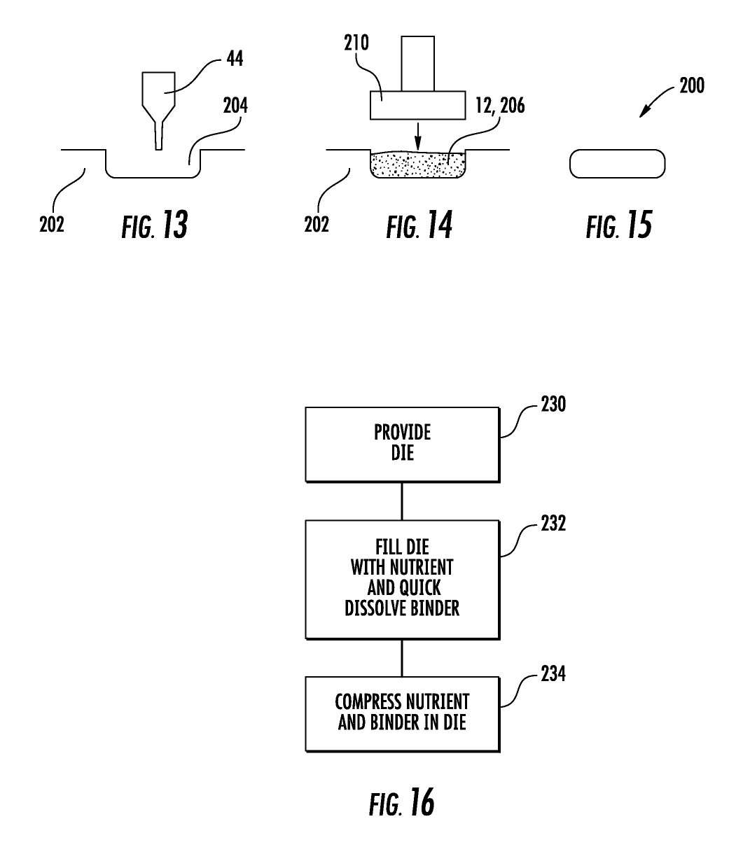

Referring now more particularly to FIGS. 13-16, a method of manufacturing the nutrition delivery apparatus 200 is shown. Initially, a die 202 is provided 230. The die 202 may have a cavity 204 which is sized and configured so that the final form of the nutrition delivery apparatus 200 can be inserted into the mouth of the water bottle 32. The nozzle 44 is disposed over the cavity 204 of the die 202. The nozzle 44 is operative to fill 232 the cavity 204 with (1) the nutrition 12 and the binder 206 or (2) the nutrition 12, the binder 206 and an effervescent material 208. Once the nutrition 12 and the binder 206 and/or effervescent material 208 are disposed within the cavity 204 of the die 202, a press 210 compresses 234 the mixture. When the press 210 is removed, the nutrition delivery apparatus 200 is removed from the cavity 204.

Referring now to FIGS. 17-20, a fourth embodiment of the apparatus 300 is disclosed. The apparatus 300 may be a pre-impregnated structure. The pre-impregnated structure may have various configurations such as strip, honeycomb, mesh, rolled rope configurations. The pre-impregnated structures 300 may be rolled or provided for transportation in a stacked fashion. By way of example and not limitation, FIG. 17 illustrates pre-impregnated structure 300a being provided as a rolled strip. In this regard, the strip 300a is flexible in nature so as to be rollable. The rolled strip 300 may be transported to a location for later mixture with water in a standard water bottle or another container useful for mixing the rolled strip 300a into the water. The rolled strip 300a may have preprinted dosage lines 302 so that the user may cut the strips to appropriate lengths for mixture with an appropriate amount of nutrition 12 and water. By way of example and not limitation, the user may mix X number of strips with 8 fluid ounces of water depending on the size of the person to provide the appropriate amount of nutrition to the person. The preprinted dosage lines 302 may additionally or alternatively be perforations formed in the strip 300a so that the user need not use a pair of scissors to cut the strip but may simply tear the strip at an appropriate perforated dosage line 302.

Referring now to FIG. 18, the strip 300a may be provided as short strips 306 instead of a long strip which is rolled up. The strip 300a may have a thickness 308 of between 1 mm and 40 mm.

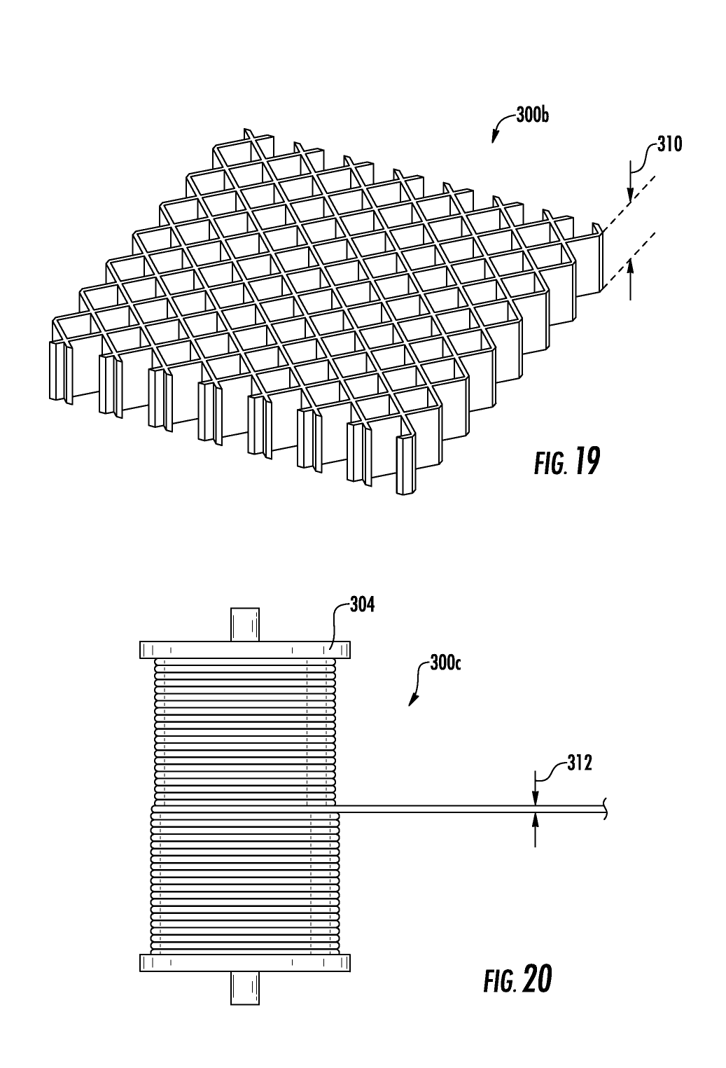

Referring now to FIG. 19, a second embodiment of the pre-impregnated structure 300b is shown. The pre-impregnated structure 300b is formed as a honeycomb structure. By forming the pre-impregnated structure into a honeycomb structure, when the apparatus 300b is submersed in water, the honeycomb structure 300b increases the surface area contact between the structure 300b and the water so as to increase the dissolveability and reduce the amount of time required to dissolve the structure 300b in the water and mix the nutrition 12 with the water. The honeycomb structure 300b is shown when flat. However, the honeycomb structure may also be provided in a rolled up form on a spool. It is also contemplated that the honeycomb structure 300b may also be cut to size with a pair of scissors or a utility knife to mix the appropriate amount of nutrition impregnated in the structure 300b with water based on the person's size. The honeycomb structure 300b may have a thickness 310 between 1 mm and 40 mm. Additionally, the honeycomb structure 300 may be provided in other configurations such as mesh or finned structure in order to increase the surface area contact between the water and the structure 300b.

Referring now to FIG. 20, a third embodiment of the pre-impregnated structure 300c is shown. The structure 300c is a rope configuration that may be rolled on a spool 304 so that the user can unwind the structure 300c and cut off the appropriate amount of nutrition based on the length of the structure 300c. The rope configuration 300c may have a diameter 312 between 1 mm and 40 mm. Moreover, the rope configuration of the structure 300c may have a single or multiple twine that are twisted with each other and may be cut to length with a scissor or utility knife. By providing multiple twines that are twisted together, such configuration increases the surface area contact between the water and the rope configured pre-impregnated structure 300c to improve dissolveability and to reduce the time to completely dissolve the structure 300c placed in the water.

The various structures 300a-c may be formed by extrusion or molding. The nutrition 12 may be mixed with a binder which is flexible when cured so that the structure 300a-c may be rolled up.

The nutrition delivery apparatus 10, 100, 200, 300 may be manufactured with multiple water dissolving substrates. By way of example and not limitation, the nutrition 12 may be provided as a tablet then disposed within the shell 14, 114. The shells 14, 114 may be layered on top of each other. Either the shell 14 may be layered under the shell 114, or the shell 114 may be layered under shell 14. Also, the shell 14, 114 and the binder 206 may be fabricated from food grade ingredients so that the nutrition delivery apparatus 10, 100, 200 may simply be mixed with water then consumed without filtering out the shell 14, 114 or binder 206 in a post processing step.

The nutrition delivery apparatus 10, 100 may be provided so that it sinks to the bottom of a water bottle after being inserted into the water bottle. The capsule 14 and the pouch 104 may be air tight and vacuumed to remove the air within the capsule 14 and the pouch 104. Additionally, the nutritional delivery apparatus 10, 100, 200 may have a solid non dissolvable core/object or a core/object that dissolve slower than the rest of the nutrients. In this manner, as the water soluble shell 14, film 102 or binder 206 dissolves, the user may shake the water bottle so that the non dissolvable or slowly dissolving core or object is used to mix the nutrition 12 with the water 16.

The various aspects described herein was in relation to a nutrition delivery apparatus that may be slipped into a narrow mouth of a water bottle. When the nutrition delivery apparatus is disposed in the water bottle, the mouth of the water bottle prevents the user from reaching in with his or her finger to rub the nutrition delivery apparatus to speed up dissolution of the nutrition delivery apparatus in the water. In this regard, the dissolution of the nutritional delivery apparatus occurs without agitation and in under 1 minute and preferably under 10 seconds. It is also contemplated that the nutrition delivery apparatus may be inserted into other types of wide mouth containers such as a water cup and a shaker bottle. In this instance, the diameter of the nutrition delivery apparatus may be significantly larger than 2 inches.

The water in which the nutrition delivery apparatus is disposed in to dissolve may be drinking water with a pH between about 6.5 to about 8.5. The temperature of such drinking water may be between 60° F. and 85° F.

The above description is given by way of example, and not limitation. Given the above disclosure, one skilled in the art could devise variations that are within the scope and spirit of the invention disclosed herein, including various ways of distribution of the nutrition delivery apparatus 10, 100, 200 to people. Further, the various features of the embodiments disclosed herein can be used alone, or in varying combinations with each other and are not intended to be limited to the specific combination described herein. Thus, the scope of the claims is not to be limited by the illustrated embodiments.

1. A method of providing an ingestible protein nutrient in a water dissolvable pouch for conveniently dropping the pouch in a disposable plastic water bottle of room temperature drinking water to dissolve the pouch and mix the ingestible protein nutrient with the drinking water so that a person can ingest the protein nutrient, the disposable plastic water bottle having an opening smaller than a width of a body of the disposable plastic water bottle, the method comprising the steps of:
providing an ingestible water dissolvable film that is capable of being dissolved in the room temperature drinking water under one (1) minute, the drinking water having a pH greater than 6, the ingestible hydroxypropyl cellulose film configured as the pouch with a cavity so that drinkable water comes into contact with contents enclosed within the pouch after the ingestible hydroxypropyl cellulose film has been dissolved, the pouch being sufficiently narrow to be inserted into the opening of the disposable water bottle and about 2 inches to about 10 inches in length, the width of the pouch being about ¼ inch to about ¾ inch;
providing the ingestible protein nutrient as a powder;
filling the powdered ingestible protein nutrient in the cavity of the pouch configured hydroxypropyl cellulose film;
sealing the pouch for holding the powdered ingestible protein nutrient until use when a user disposes the container with the formulation into a disposable water bottle with drinkable water, shakes the disposable water bottle to mix the powdered ingestible protein nutrient as the ingestible hydroxypropyl cellulose film dissolves in the drinkable water.

2. The method of claim 1 wherein the providing the ingestible protein nutrient as a powder step further comprises the step of providing an effervescent substance and mixing the effervescent substance with the ingestible protein nutrient.

3. A method of manufacturing a container with a formulation for conveniently mixing an ingestible protein nutrient with drinkable water, the method comprising the steps of:
providing an ingestible water dissolvable binder that is sufficiently dissolvable in drinkable water under one (1) minute, the binder being sodium bicarbonate, stearic acid, magnesium stearate or combinations thereof, the ingestible water dissolvable binder providing a solid form when cured, a width of the solid form being sufficiently narrow to be inserted into an opening of a disposable water bottle and a length of the solid form being about 6 inches in length;
providing the ingestible protein nutrient as a powder;
mixing the ingestible water dissolvable binder and the powdered ingestible protein nutrient;
filling a die with the mixed ingestible water dissolvable binder and powdered ingestible protein nutrient;
compressing the mixed ingestible water dissolvable binder and powered ingestible protein nutrient.

4. The method of claim 3 further comprising the steps of:
providing an effervescent material;
wherein the mixing step comprises the step of mixing the ingestible water dissolvable binder, the effervescent material and the powdered ingestible protein nutrient;
wherein the filling step comprises the step of filling the die with the mixed ingestible water dissolvable binder, the effervescent material and powdered ingestible protein nutrient;
wherein the compressing step comprises the step of compressing the mixed ingestible water dissolvable binder, the effervescent material and powered ingestible protein nutrient.

5. The container of claim 3 wherein the solid form is a film sheet.

6. The container of claim 3 wherein the solid form has a mesh configuration.

7. The container of claim 3 wherein the solid form has a honeycomb configuration.

8. The container of claim 3 wherein the solid form has a rope configuration.

9. The container of claim 8 wherein the rope configured solid form has multiple twines.

10.-27. (canceled)
